(19) United States
(12) Patent Application Publication
(10) Pub. No.: US 2010/0042644 A1
(43) Pub. Date: Feb. 18, 2010

(54) TREE-STRUCTURED DATA DISPLAY

(75) Inventors: Scott A. Judy, Newnan, GA (US); Christopher J. Jeffs, Roswell, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/541,434

(22) Filed: Aug. 14, 2009

Related U.S. Application Data
(60) Provisional application No. 61/089,265, filed on Aug. 15, 2008.

(51) Int. Cl. G06F 17/30; G06F 3/048; G06F 17/00

(52) U.S. Cl. 707/102; 715/853; 700/94; 707/E17.005

(57) ABSTRACT

Some general aspects of the invention relate to systems and computer-implemented methods of generating a treemap display. A collection of data elements characterized by a first attribute is accepted, and some data elements are grouped into a first set of data elements according to a first rule associated with the first attribute. A treemap field is partitioned into a collection of cells according to the grouping result, and the collection of cells includes a first cell representing the first set of data elements. The first cell has a first dimension corresponding to a value of the first attribute of the first set of data elements. The first set of data elements is then divided into a collection of subsets of data elements according to a second rule. Correspondingly, the first cell of the treemap field is partitioned into a collection of sub-cells according to the division. Each sub-cell represents a respective one of the plurality of subsets of data elements.

### CROSS-REFERENCE TO RELATED APPLICATIONS

This application claims the benefit of U.S. Provisional Application No. 61/089,265 filed Aug. 15, 2008, the contents of which are incorporated herein in its entirety.

### BACKGROUND

This application relates to data display in a treemap format.

A treemap is a useful tool to represent hierarchical (e.g., tree-structured) data in a constrained space. A treemap typically consists of a group of two-dimensional cells (e.g., rectangles) that each corresponds to a respective portion of the data (e.g., a branch of a tree). Each cell may further contain subdivisions (e.g., sub-rectangles) that represent data of lower hierarchy (e.g., a sub-branch or a leaf of the branch). A cell can have several dimensions (e.g., size and color) that are correlated with various characteristics of the data. For example, the size of a cell can correspond to one statistic about the data, whereas the color of a cell can correspond to another statistic.

### SUMMARY

One general aspect of the invention relates to a computer-implemented method of generating a treemap display. A collection of data elements characterized by a first attribute is accepted, and some data elements are grouped into a first set of data elements according to a first rule associated with the first attribute. A treemap field is partitioned into a collection of cells according to the grouping result, and the collection of cells includes a first cell representing the first set of data elements. The first cell has a first dimension corresponding to a value of the first attribute of the first set of data elements. The first set of data elements is then divided into a collection of subsets of data elements according to a second rule. Correspondingly, the first cell of the treemap field is partitioned into a collection of sub-cells according to the division result. Each sub-cell represents a respective one of the plurality of subsets of data elements.

Some embodiments may include one or more of the following features.

The first dimension of the first cell that corresponds to the value of the first attribute includes cell size. In some examples where the collection of data elements is further characterized by a second attribute, the first cell is configured to have a second dimension corresponding to a value of the second attribute of the first set of data elements. The second dimension of the first cell may include a color.

In some examples, the first set of data elements is associated with a first set of audio files. The area of the first cell may correspond to a volume of the first set of audio files, and the color of the first cell may correspond to an average time length of the first set of audio files.

In some examples, in order to group data elements into the first set of data elements, the collection of data elements is first ranked in descending order based on the respective value of the first attribute of each data element. A first data element is then compared with a second data element that immediately follows the first element in the rank to determine whether the first data element is in the same group as the second element. In some further embodiments, a n^{th} data element is iteratively compared with a n+1^{th} data element that immediately follows the n^{th} data element in the rank to determine whether the n^{th} data element is in the same group as the n+1^{th} data element.

Another general aspect of the invention also relates to a computer-implemented method of generating a treemap display. A collection of data elements characterized by a first attribute and a second attribute is accepted, and a treemap field is partitioned into a collection of cells based on a rule. Each cell represents a respective group of data elements and has at least a first and a second dimension corresponding to the first and second attributes respectively.

Embodiment of this aspect may include one or more of the following features.

In some examples, each of the collection of cells is partitioned into a respective set of sub-cells based on the rule, and each sub-cell represents at least a sub-group of the group of data elements represented by one of the collection of cells. Each sub-cell has at least the first and second dimension corresponding to the first and second attributes respectively. In some further examples, each sub-cell is iteratively partitioned based on the rule.

In some examples, the collection of cells is first ranked in descending order by the first dimension, and the location of each cell on the treemap is determined based on its corresponding ranking.

The collection of data elements is represented in a tree-based structure. The tree-based structure may be generated based at least on one of the first and second attributes.

In some examples, the tree-based structure includes a first level of nodes each corresponding to one of the groups of data elements, and a second level of nodes each corresponding to one of the sub-groups of data elements. The first dimension of a cell may include size, and the second dimension may include color.

The collection of data elements may be associated with a library of audio files, for example, recordings of calls placed at a call center. Each of the first and second attributes of the data elements may include one or more of the following: a volume of a group of audio files having a common characteristic, an average handle time of the group of audio files, a median handle time of the group of audio files, a standard deviation of the individual handle time of each one of the group of audio files, and a customer satisfaction feedback score associated with the audio files.

A further aspect of the invention relates to a system for generating a treemap display representing a plurality of data elements. The system includes an interface for accepting a selection of display mode and for receiving a description of the plurality of data elements characterized by a first attribute and a second attribute; and a processor for partitioning a treemap field into a plurality of cells according to the selection of the mode of display, where each cell represents group of data elements. The processor is further configured for computing a size of each of the plurality of cells based on the first attribute; and computing a color of each of the plurality of cells based on the second attribute.

Embodiments may include one or more of the following features.

In some examples, the mode of display includes one or more of the following: a “global” mode, a “selected sessions” mode, a “sessions only” mode, a “per session” mode, and an “animated” mode.

The processor may be further configured for grouping at least some of the plurality of data elements into a first set of data elements according to a first rule associated with the first attribute; partitioning the treemap field into a plurality of cells according to the grouping result, the plurality of cells including a first cell representing the first set of data elements, the first cell having a size corresponding to a value of the first attribute of the first set of data elements; dividing the first set of data elements into a plurality of subsets of data elements according to a second rule; and partitioning the first cell of the treemap field into a plurality of sub-cells according to the division, each sub-cell representing a respective one of the plurality of subsets of data elements. In some examples, the processor is also configured for re-partitioning the treemap field in response to a modification in the selection of display mode.

Embodiments of various aspects may include one or more of the following advantages.

One application of a treemap is in audio analytics, including, for example, tracking audio sessions and query results for a call center. By visualizing calls that match specific queries in grouped regions of the map, where each region has multiple dimensions representing various statistics of the calls, areas of concern to a call center may be quickly identified in a visually intuitive way. In some embodiments, the area of each group may correspond to the call volume (number of calls or audio files) and the color of the group may correspond to the average handle time of the calls matching a specific query. Multiple “sessions”, each containing distinct audio files (calls) and queries, can also be simultaneously displayed in a treemap. In some circumstances (for example, where a new session is defined on a subset of an old session), different sessions may also contain a common set of audio files.

As the number of sessions, queries, and calls tracked by a call center analytics system increases, there is an increasing challenge to identify relevant data and to navigate the data to retrieve useful information. The treemap tool described in this application can help both by visually identifying sets of calls that differ from the norm (or from the past) in handle time or in call volume, and by providing a landing page from which a user may dive into the details of specific sessions, queries, and calls that are representative of a trend of interest.

Other features and advantages of the invention are apparent from the following description, and from the claims.

### DESCRIPTION OF DRAWINGS

FIG. 1 is a treemap according to one embodiment of the invention.

FIG. 2 is an exemplary application of a treemap in audio analytics.

FIG. 3A is a block diagram of a data processing system suitable for generating the treemap shown in FIG. 1.

FIG. 3B is a flow diagram of a procedure for generating the treemap by the data processing system shown in FIG. 3A.

FIGS. 4A-4E are diagrams illustrating a two-stage algorithm for grouping nodes.

FIG. 5 is a flow diagram of a procedure for conforming session nodes and query nodes to a treemap using the two-stage algorithm in FIGS. 4A-4E.

FIGS. 6A-6D are exemplary treemaps in “Global” mode, “Selected Sessions” mode, “Session Only” mode, and “Per Session” mode, respectively.

FIG. 7 is a screenshot of a configuration window used for generating the treemaps shown in FIGS. 6A-6D.

FIG. 8 is a flow digram of a procedure for conforming an N-level data structure to a treemap by iteratively applying the two-stage algorithm shown in FIGS. 4A-4E.

### DETAILED DESCRIPTION

### 1 Data Display by Treemap

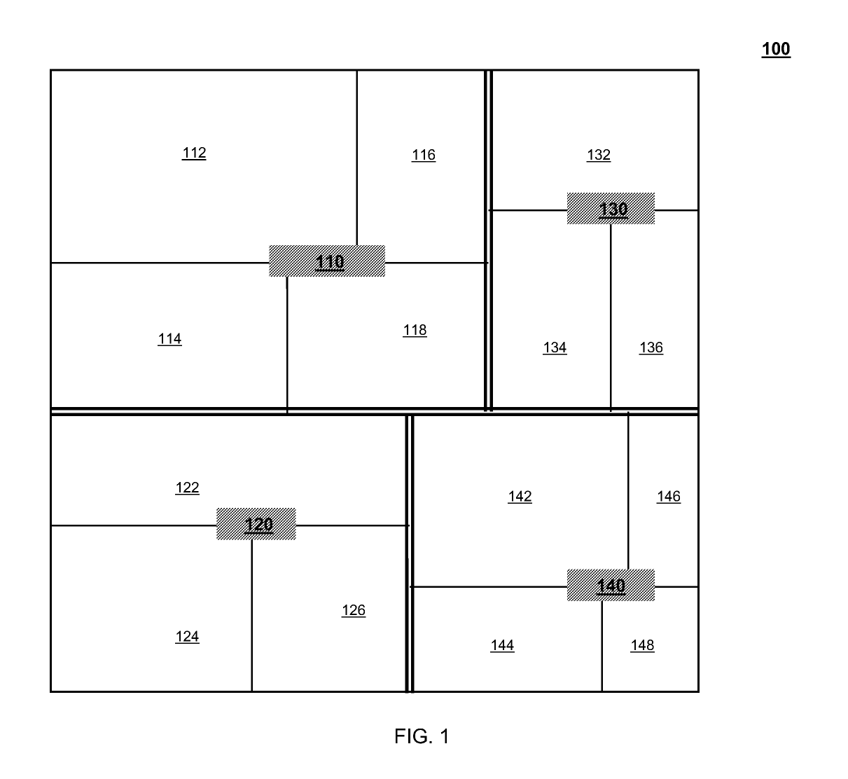

Referring to FIG. 1, one embodiment of a treemap 100 that represents tree-structured data is shown. Here, the treemap 100 includes four rectangles 110, 120, 130, and 140, each refereed to as a “region.” Here, a region generally represents a collection of cells grouped together for the purpose of display. Each region can be separated from other regions by borders, for example, displayed here in double lines.

Each region of the treemap 100 includes multiple cells that are also shown in rectangles. For example, region 110 contains cells 112, 114, 116, and 118. A cell can represent data of the smallest unit, or alternatively, further include a set of sub-cells. Each cell has at least three dimensions, including the size, the color, and the region to which it belongs. Each of the three dimensions can be used to represent a respective characteristic of the data that the cell represents, as will be described in greater detail later.

By encoding various aspects of data characteristics in a compact and organized display, the treemap 100 provides a visual representation of a high-level overview that allows users to navigate through the data and obtain information for identifying particular areas of interest. Such a treemap layout can be useful in many applications, including, for example, display of stock prices, photo albums, and distributed networks. The following embodiments will be described primarily in the context of audio analytics.

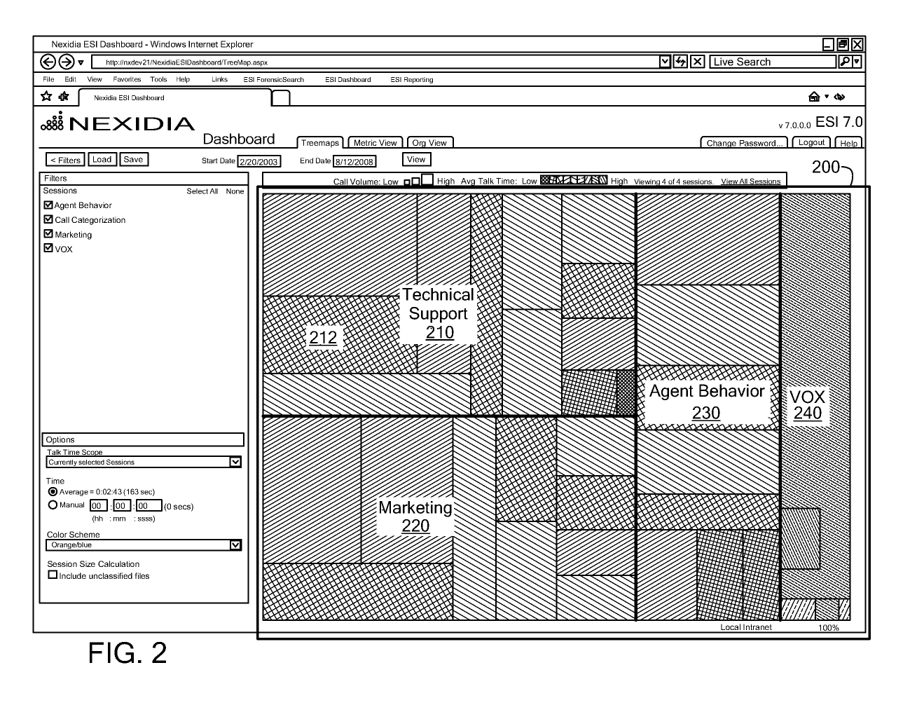

FIG. 2 is a screenshot of a Nexidia Dashborad webpage that uses an exemplary treemap 200 for displaying audio sessions and query results for an audio archive of a call center. (In some embodiments, the treemap 200 may also be referred to as an activity map and/or executive dashboard.) Generally, a call center stores an archive of audio files that can be grouped by different categories (“sessions”). Examples of sessions include “technical support,” “marketing,” “agent behavior,” and “VOX.” For each new audio file that is included in (or otherwise stored in association with) the archive, a set of “queries” are run against the file to help determine, for example, the contents and the destination of the file. Examples of queries include “Is this call about an installation failure?” “Is this call about a market promotion?” and “Would you like to provide feedback on customer service?” The “hits” generated by this query process are stored in a database for future analysis. In one example, the results of the query process are indicative of which queries “hit” on which files in which session. As the archive expands, the increasing number of audio files, queries, and sessions can lead to growing difficulty in managing and displaying the vast amount of information contained in the entire archive.

In this example, treemap 200 provides an effective visual representation for revealing condensed information to viewers. Here, each one of regions 210, 220, 230, and 240 represents a set of audio files that belongs to a particular session. For example, region 210 represents audio files that are directed to the session of “technical support.” Within this session, files are further organized by subdivisions, for example, according to result of queries. For instance, cell 212 may represent files that match the query of “Is this call about an installation failure?” in the session of “technical support.”

The color and size of subdivisions are designed to represent characteristics of calls associated with this subdivision. Depending on implementation, the color of cell 212 may be provided in RGB- or grey-scale to represent the average handle time of the calls associated with this cell, and the size may represent the call volume (e.g., number of audio files). Other characteristics that can be represented either by color or size include the median handle time of calls, standard deviation of the individual handle time of the calls in this subdivision, the number of transfers, the number of hits for a specific query, customer satisfaction feedback scores, and etc.

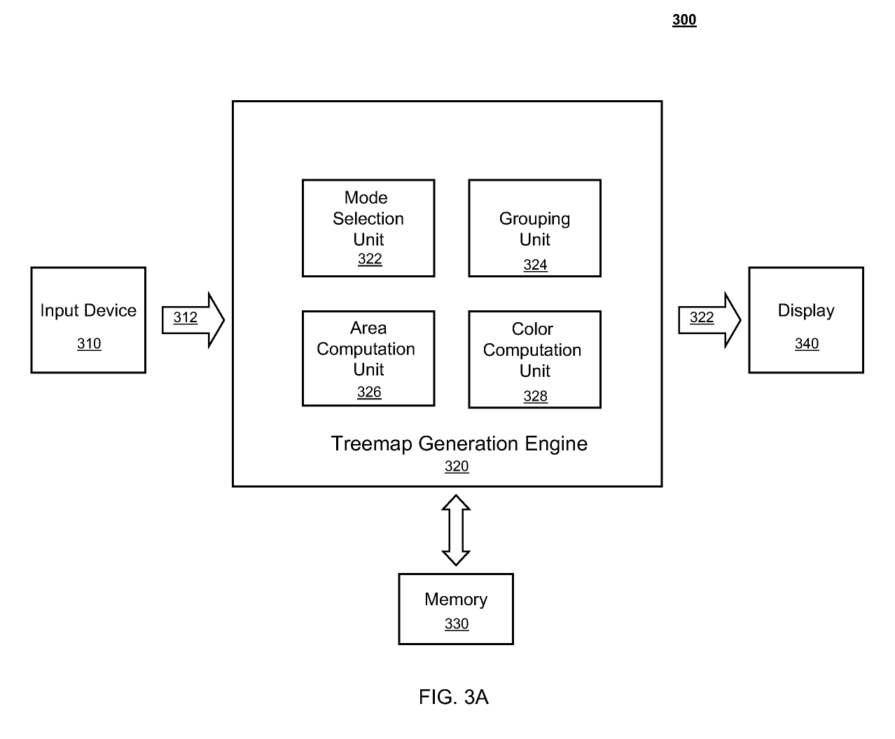

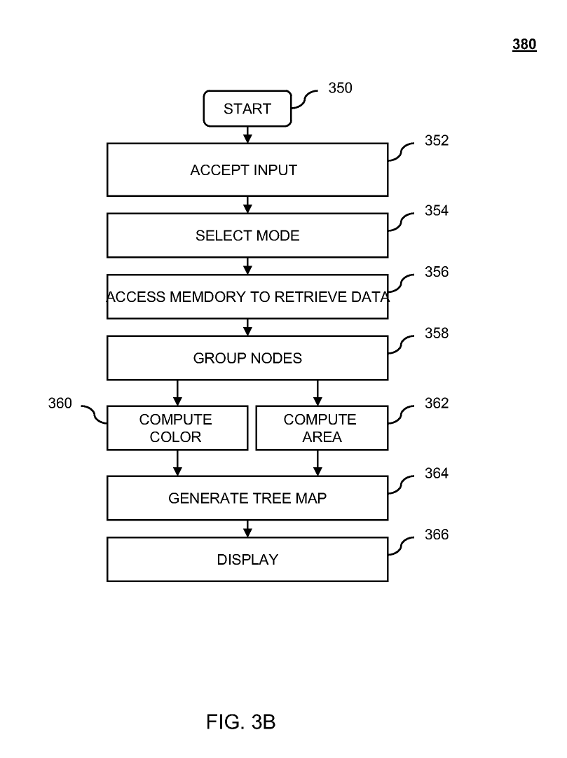

Referring to FIG. 3A, a block diagram 300 illustrates one implementation of a treemap generation engine 320 configured to generate the treemap 100 shown in FIG. 1. Upon receiving input data 312 from an input device 310 (e.g., a keyboard, mouse and/or keypad), the treemap generation engine 320 communicates with a memory 330 to obtain relevant data (e.g., information on the audio files to be visualized, including “hits” of the files) and generates a treemap 322 to be shown on a display unit 340 (e.g., a computer screen). More specifically, the treemap generation engine 320 includes a mode selection unit 322, a grouping unit 324, an area computation unit 326, and a color computation unit 328, each configured to perform functionalities as described below.

Referring to FIG. 3B, a flow diagram 380 illustrates an exemplary procedure of the treemap generation engine 320. First, in step 352, the treemap generation engine 320 accepts input from the input device 312, including for example, instructions on the portions of data from the archive to be display and/or the mode of display. By providing users with different modes of display, the treemap generation engine is capable of presenting useful information to users of various interests in different levels of detail desired in specific applications. Examples of various modes available for display include “global mode,” “sessions only mode,” “selected sessions mode,” and “per session mode,” as will be described in detail later. Next, in steps 354 and 356, the mode selection unit 322 selects the mode of display based on input and accesses the memory 330 to obtain data for treemap generation. Data retrieved from the memory 330 include nodes (e.g., data representing groups of audio files) to be displayed in the treemap and their attributes (e.g., file lengths, number of query “hits,” and number of transfers).

Subsequently, in step 358, the grouping unit 324 uses a recursive algorithm to group nodes into sets and determines the locations and dimensions of individual rectangular cells that will be used to represent the sets and nodes. Based on the grouping result, the area computation unit 326 and color computation unit 328 respectively determines the area and color of each cell, in step 360 and 362. The treemap generation unit 320 then generates the treemap in step 364, and display the treemap in the selected mode in step 366.

### 2 Node Grouping

Depending on implementation, there are various approaches to grouping nodes in a tree structure and subsequently conforming them to cells on a treemap in order to increase readability of the treemap. One approach, for example, places groups of nodes of larger size in the upper left sections of the map and groups of smaller sizes in the lower right sections. Described below is a two-stage recursive algorithm developed for this approach.

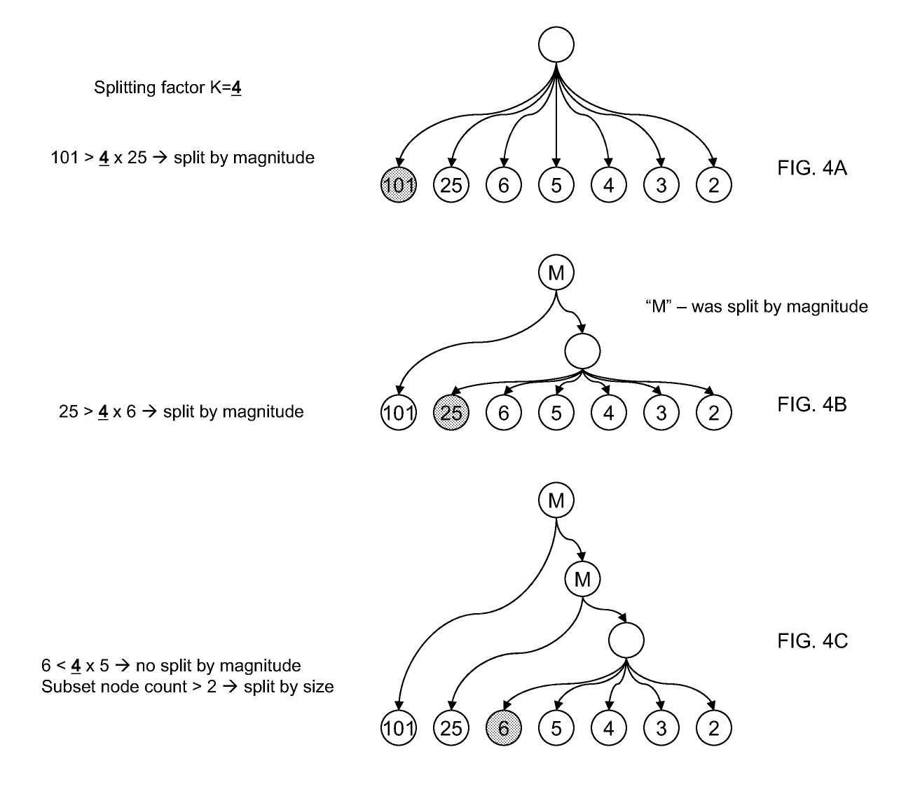

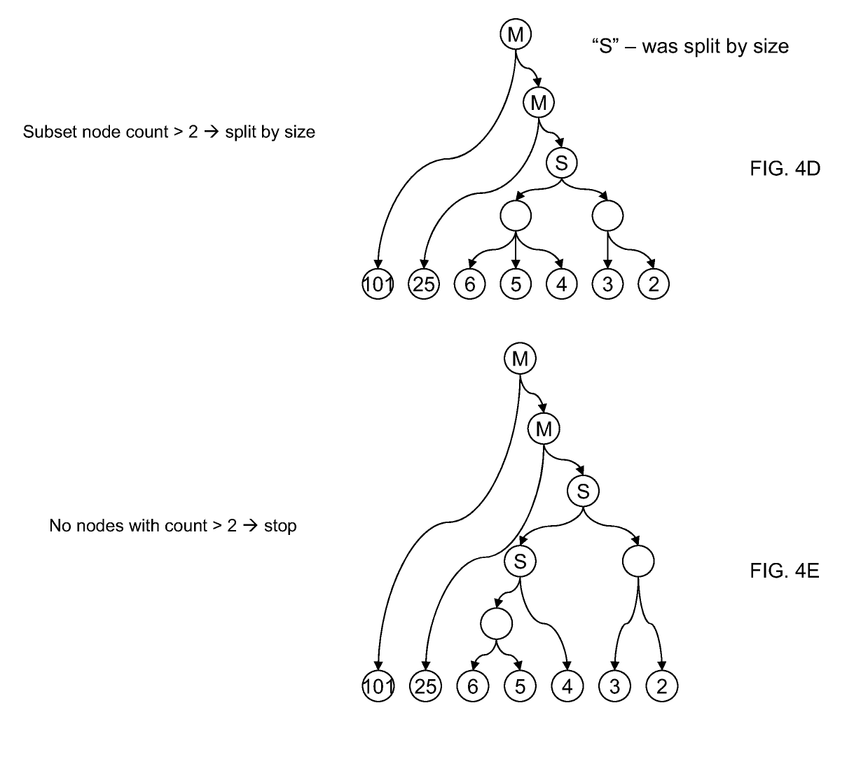

Referring to FIGS. 4A-4E, this algorithm includes two stages of grouping: 1) recursively grouping nodes by magnitude; and 2) recursively grouping nodes by size within each magnitude group.

Here, a node refers to a unit of subdivision, for example, ingest sessions, structured queries, or search terms. Therefore, a node can be a session node, a query node, a search term node, or other types of nodes. The size of a node refers to the call volume (e.g., the number of audio files) associated with the node. For example, a query node of “installation failure” having a size “101” indicates that there are 101 audio files that match the query “installation failure.” In some implementations, a query node is specifically tied to the session it situates. That is, a query node “installation failure” in session “technical support” differs from a query node “installation failure” in session “agent behavior.” The size of the query node therefore represents the call volume directed to a query in a specific session.

FIGS. 4A-4C illustrate a process of the first stage—grouping nodes by magnitude. First, a set of nodes are ranked by their size in a descending order (shown in FIG. 4A). Using a splitting factor K, the grouping unit 324 checks from the first node to determine whether a node should be split from the rest of the nodes. For example, given splitting factor K equal to 4, the grouping unit 324 finds that the size of the first node (i.e., 101) is larger than K times the size of the second node (i.e., 25). As a result, the first node becomes the first “magnitude group,” and the remaining nodes are deemed as a new set of nodes on which the grouping unit 324 iterates the splitting. Similarly, the second node becomes the second “magnitude group” and its subsequent nodes are grouped as a new set (shown FIG. 4B). When the iteration reaches a node that has a size smaller than K times the size of its immediate follower, the grouping unit 324 proceeds to the following note without splitting. Once all of the nodes have been scanned and grouped by magnitude, the grouping unit 324 enters the second stage of grouping as described below.

FIGS. 4D and 4E illustrate a process of the second stage—grouping by size within each magnitude group. This part of the process can be described by the following pseudo code:

For (int i=0; i < nodeCount; i++) {
Division[i*2/nodeCount]. Add(node[i]);
}

When there are no more subgroups that have more than two nodes, the node grouping process completes.

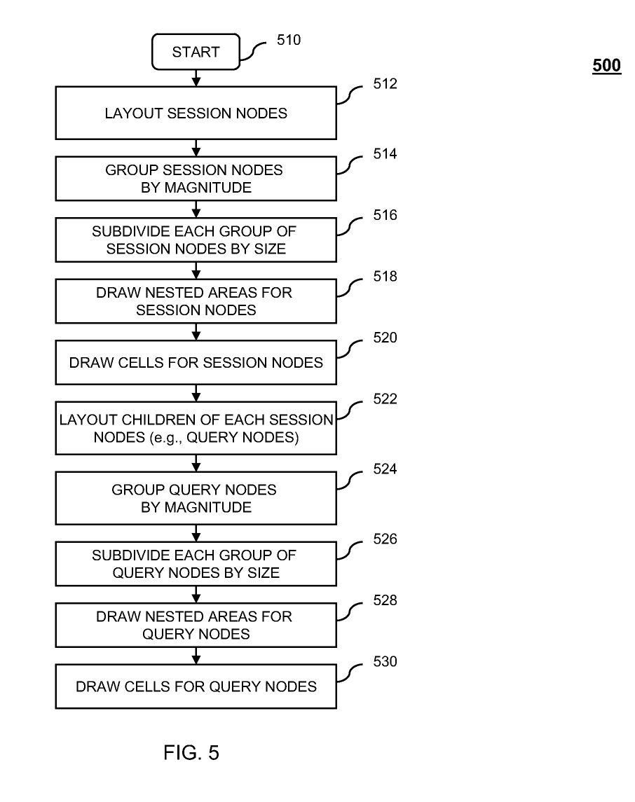

FIG. 5 further illustrates in a flow diagram 500 an exemplary procedure to generate treemap cells based on session nodes and query nodes grouped by the two-stage algorithm describe above. In step 512, session nodes are first ranked in descending order of size. Here, the session size can be the number of calls associated with the session. In steps 514 and 516, these session nodes are grouped into subsets first by magnitude and then by size, using the two-stage recursive algorithm. In step 518, nested areas for each subset of session nodes on a treemap are drawn according to the grouping result, for example, by placing the subset of session nodes that has the largest size on the top left corner of the map and the remaining subsets in corresponding orders. In step 520, cells for individual session nodes within the nested area are drawn. Border lines between cells may also be drawn according to a predefined pattern (e.g., double lines or thick white lines).

Once cells of the session nodes are drawn in the map, in step 522, children nodes of each session node (e.g., query nodes) are ranked in descending order of size. In steps 524 and 526, children of each session node are grouped into subsets again using the two-stage recursive algorithm. In steps 528 and 530, cells for each child node are then created in a similar way as described for the session node above.

### 3 Color Computation

As described earlier, each node of a data tree can be represented as a rectangular cell in a treemap. The color of a cell can be used to represent one or multiple characteristics of the corresponding node. In one embodiment, the color of each rectangle corresponds to the average handle time (AHT) of calls associated with the node (or average duration of the audio files). In this embodiment, there are three “anchor colors,” corresponding to an “average AHT,” a “maximum AHT,” and a “minimum AHT.” When a RGB color model is used, these three anchor colors can be, for example, blue, red, and green, respectively. Depending on whether the AHT of an individual rectangle is longer or shorter than an “overall average” value AHTavg (e.g., an overall average length of the calls in this session, or an overall average length of the calls in the entire data set), the color of the rectangle is computed by fading between the “maximum AHT” color and the “average AHT” color (when AHT>AHTavg), or by fading between the “minimum AHT” color and the “average AHT” color (when AHT<AHTavg). This fading can be done using in a logarithmic fashion or a linear fashion, for example by applying a fading function.

### 4 Area Computation

The area of a cell in a treemap can also be used to represent one or multiple characteristics of the node associated with the cell. In the embodiment described with reference to FIG. 5, the area of each rectangle corresponds to the number of calls (audio files) that match the corresponding session and query combination of the node (e.g., node size).

In some implementations, the areas of cells within a single session are drawn to the same scale, for example, based on the corresponding call volume of each cell. The area of cells that represent sessions, however, are scaled relative to the number of calls in the session that have at least one structured query or search term hit, rather than the total call volume in the session. Therefore, the area of one cell in one session may not be directly comparable to the area of another cell in different session based on their call volumes.

### 5 Mode Selection

Note that variations of the above-described processes of node grouping, color computation, and area computation may be implemented depending on the specific mode of display selected by users or compute programs. Each mode may present user with data shown in selected portions and to the extent of detail desired. By switching between various display modes, users can navigate through data and identify areas of interest for further study. For illustrated purposes, the following section further describes of four exemplary display modes.

### 5.1 “Global” Mode

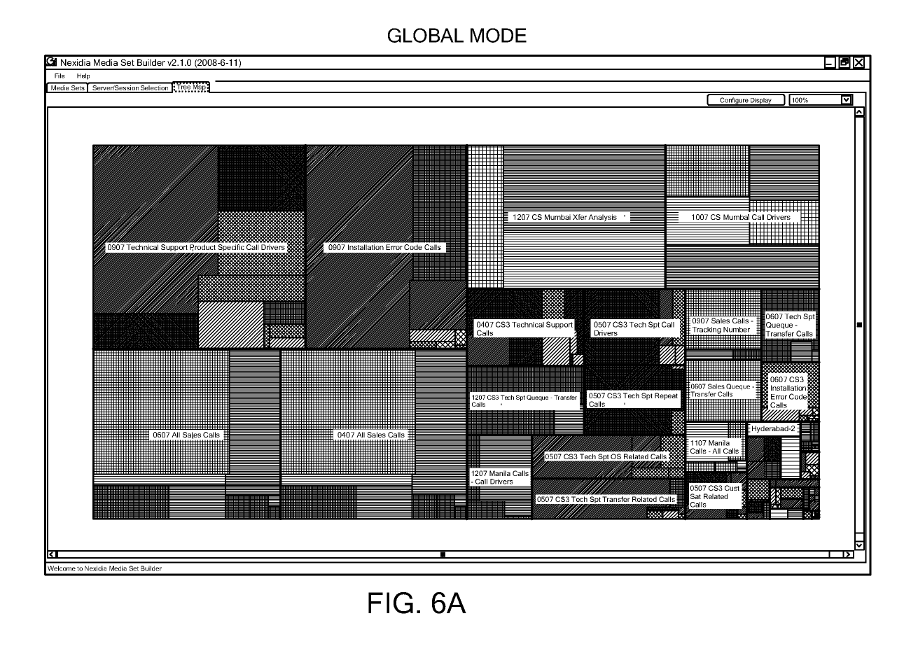

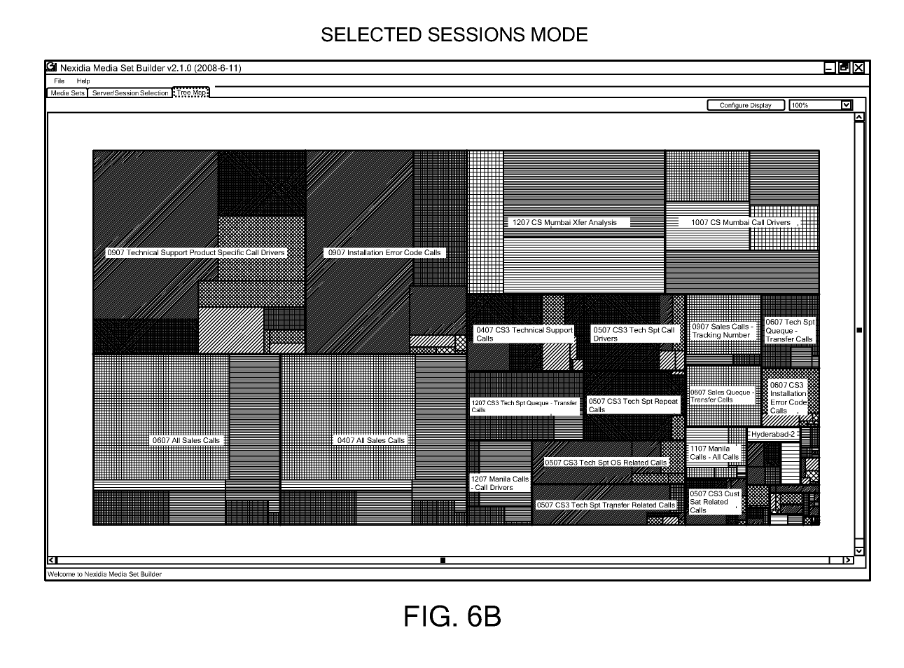

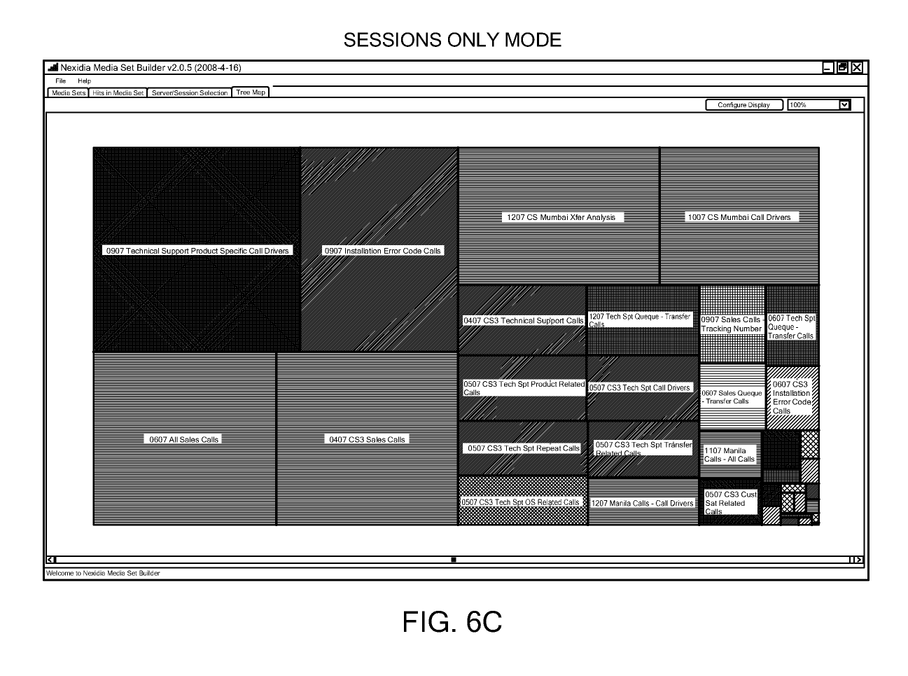

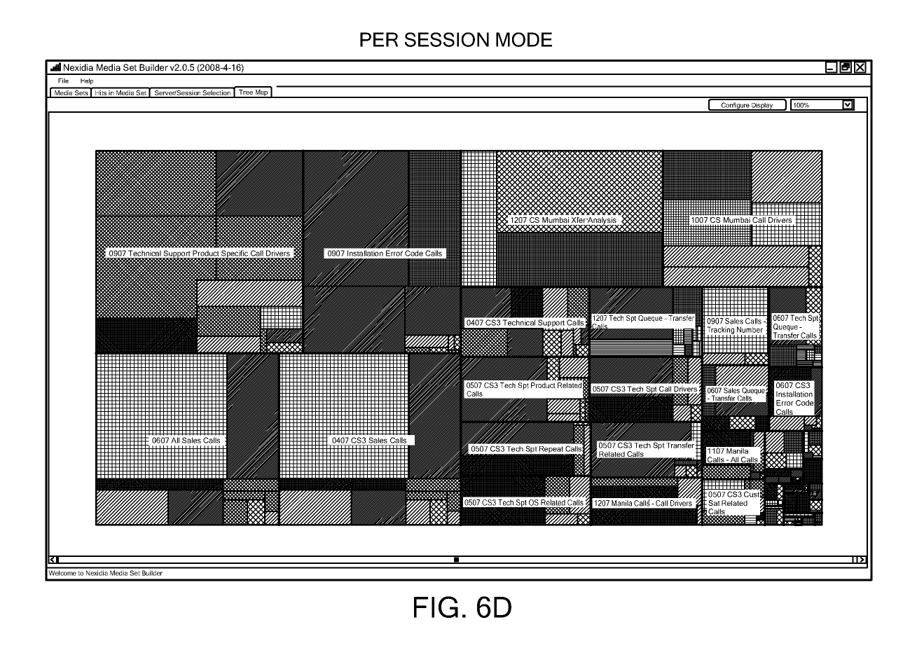

FIG. 6A illustrates an exemplary treemap display in “Global” mode.

In this “Global” mode, the entire collection of sessions or a group of selected sessions is displayed in the treemap as rectangles bordered by white lines. Within each session area, query nodes are displayed as rectangles of different colors.
Area computation: Areas for session nodes are allocated based on the number of files within a session that match one or more queries. Areas for query nodes within each session are allocated based on the number of files in the session that match that particular query.
Color computation: The maximum, minimum, and average AHT values used for color computation are drawn from the AHTs of all individual query-session combinations in the entire dataset, regardless of whether a session is selected for display or not.

### 5.2 “Selected Sessions” Mode

FIG. 6B illustrates an exemplary treemap display in “Selected Sessions” mode.

In this “Selected Sessions” mode, a group of selected session is displayed in the treemap as rectangles bordered by white lines. Within each session area, query nodes are displayed as rectangles of different colors.
Area computation: Same as in the “Global” mode, the areas for session cells are allocated based on the number of files within a session that match one or more queries. Areas for query cells within each session are allocated based on the number of files in the session that match that particular query.
Color computation: The maximum, minimum, and average AHT values used for color computation are drawn from the AHTs of the individual query rectangles across the group of selected/displayed sessions.

### 5.3 “Sessions Only” Mode

FIG. 6C illustrates an exemplary treemap display in “Sessions Only” mode.

In this “Sessions only” mode, the treemap only shows the session divisions of audio files, not the individual queries. Therefore, no query cells are shown within each session cell.
Area computation: Areas of the session cells may correspond to the number of all files in the session, or alternatively, correspond to the number of files in the session that mach one or more queries.
Color computation: The maximum, minimum, and average AHT values for color computation are drawing from the AHTs of the session rectangles.

### 5.4 “Per Session” Mode

FIG. 6D illustrates an exemplary treemap display in “Per Session” mode.

In this “Per Sessions” mode, a group of selected session is displayed in the treemap as rectangles bordered by white lines. Within each session area, query nodes are displayed as rectangles of different colors.
Area computation: Same as for “Selected Sessions” mode.
Color computation: The maximum, minimum, and average AHT values for color computation are local to a session and are drawn only from the query cells within each session area. The resulting colors of each query cell will therefore indicate whether the AHT of individual query is above or below the session average.

### 5.5 Other Modes

In addition to the four examples described above, there are many alternative display modes suitable for use. For example, the treemap may be configured in an animated mode, such the color and size of each cell can change, for example, by tracking and filtering and calls against a specific time frame or other metadata, such as “call center.” In such an animated view, it may be possible to see a specific type of call grow as a proportion of the total calls over time, or to watch the average time of a specific type of call change over time indicating, for example, that agents have become more proficient in handling such type of calls. In fact the ability to display a treemap on such filtered data is implemented, but not with animation or automated sequencing of views.

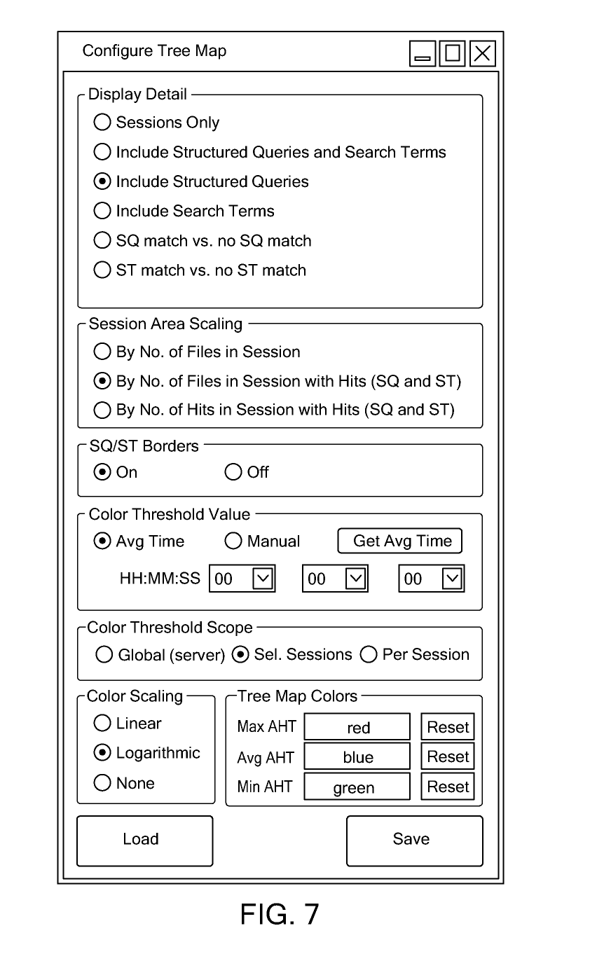

FIG. 7 illustrates an example of how some of the display options described above can be made configurable in software.

### 6 Alternative Embodiments

In addition to the area computation approach described in section 4, there are several alternative approaches for computing areas of rectangular cells in a treemap. For example, the area of a session cell can be determined based on the number of audio files in the session, regardless whether the files contain hits (match queries) or not. In a second example, the area of a session cell can be determined based on the number of audio files with hits (but only count a file once, even if it has multiple hits). In a third example, the area of a session cell can be determined based on the number of hits on the audio files (that is, a file with multiple hits will be counted as multiple instances).

There are also alternative approaches for node grouping. For example, the grouping unit 324 may use a single-stage recursive algorithm that divides nodes into two groups such that the ratio of the sums of the node sizes in each group equals the square of the golden ratio. To find the correct division of nodes, multiple intermediate sums are computed and compared. Although this algorithm may be potentially slower, it is likely to make better choices in the presence of unusual or worst-case data.

In each of the display modes, the AHTavg time used for color computation can also be set manually to a time desired by the user (e.g., artificially enhanced or lowered), so that the colors of the cells are computed with reference to a desired average handle time rather than an actual average handle time.

Although the treemaps described above and shown in FIGS. 2, 6A-6E include two nesting levels (i.e., sessions and queries), in practice, a treemap suitable for use in this application can contain an arbitrary number of levels (e.g., a treemap of files/file sizes in a directory structure on a file system). One example of a treemap having a three-level structure includes, for example, multiple data repository (or server) cells, each of which include multiple session cells, each of which further include multiple query cells.

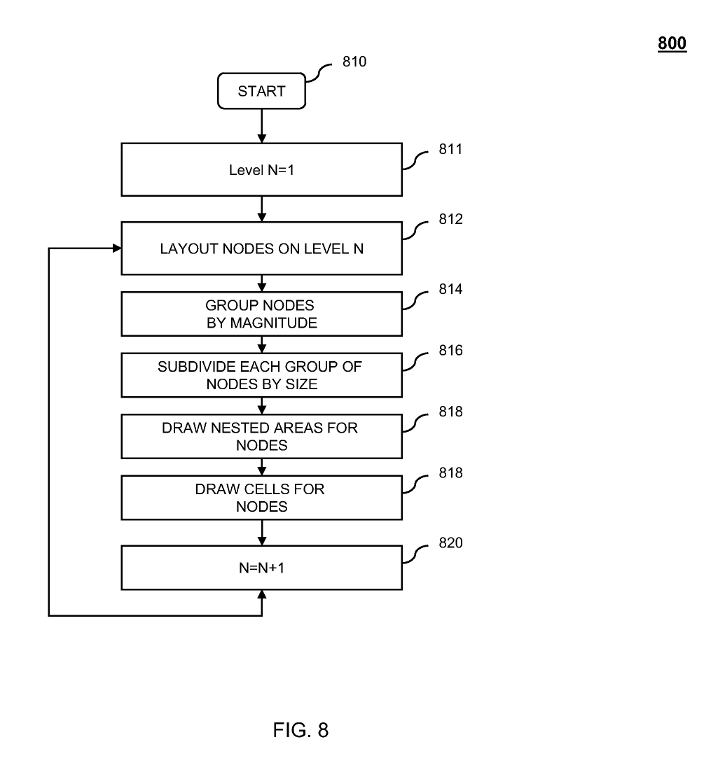

FIG. 8 illustrates in a flow diagram 800 an exemplary procedure to generate multiple levels (N-levels) of treemap cells using the two-stage algorithm described above. In a manner similar to the procedure described in FIG. 5, for each level of nodes (e.g., session nodes or query nodes), the treemap generation engine 320 iterately performs steps 812 through 821 to draw corresponding cells in the treemap until the bottom level of nodes have been conformed into cells. For the above example with a three-level data structure, the data repository cells are first drawn at N=1, the session cells are drawn at N=2, and the query cells are drawn at N=3.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention.

What is claimed is:

1. A computer-implemented method of generating a treemap display, comprising:
accepting a plurality of data elements characterized by a first attribute;
grouping at least some of the plurality of data elements into a first set of data elements according to a first rule associated with the first attribute;
partitioning a treemap field into a plurality of cells according to the grouping result, the plurality of cells including a first cell representing the first set of data elements, the first cell having a first dimension corresponding to a value of the first attribute of the first set of data elements;
dividing the first set of data elements into a plurality of subsets of data elements according to a second rule; and
partitioning the first cell of the treemap field into a plurality of sub-cells according to the division, each sub-cell representing a respective one of the plurality of subsets of data elements.

2. The computer-implemented method of claim 1, wherein the first dimension of the first cell includes size.

3. The computer-implemented method of claim 2, wherein the plurality of data elements is further characterized by a second attribute, and the first cell is configured to have a second dimension corresponding to a value of the second attribute of the first set of data elements.

4. The computer-implemented method of claim 3, wherein the second dimension of the first cell includes a color.

5. The computer-implemented method of claim 4, wherein the first set of data elements is associated with a first set of audio files.

6. The computer-implemented method of claim 5, wherein the area of the first cell corresponds to a volume of the first set of audio files, and the color of the first cell corresponds to an average time length of the first set of audio files.

7. The computer-implemented method of claim 1, wherein grouping at least some of the plurality of data elements into a first set of data elements includes:
ranking the plurality of data elements in descending order based on the respective value of the first attribute of each data element; and
comparing a first data element with a second data element that immediately follows the first element in the rank to determine whether the first data element is in the same group as the second element.

8. The computer-implemented method of claim 7, wherein grouping at least some of the plurality of data elements into a first set of data elements further includes:
iteratively comparing a n^{th} data element with a n+1^{th} data element that immediately follows the n^{th} data element in the rank to determine whether the n^{th} data element is in the same group as the n+1^{th} data element.

9. A computer-implemented method of generating a treemap display, comprising:
accepting a plurality of data elements characterized by a first attribute and a second attribute; and
partitioning a treemap field into a plurality of cells based on a rule, each cell representing a respective group of data elements and having at least a first and a second dimension corresponding to the first and second attributes respectively.

10. The computer-implemented method of claim 9, further comprising:
partitioning each of the plurality of cells into a respective set of sub-cells based on the rule, each sub-cell representing at least a sub-group of the group of data elements represented by one of the plurality of cells, each sub-cell having at least the first and second dimension corresponding to the first and second attributes respectively.

11. The computer-implemented method of claim 10, further comprising:
iteratively partitioning each sub-cell based on the rule.

12. The computer-implemented method of claim 11, further comprising:
placing the plurality of cells in descending order by the first dimension; and
determining the location of each of the plurality of cells on the treemap based on the placement of the plurality of cells.

13. The computer-implemented method of claim 9, wherein the plurality of data elements are represented in a tree-based structure.

14. The computer-implemented method of claim 9, further comprising:
generating a tree-based structure representing the plurality of data elements based at least on one of the first and second attributes.

15. The computer-implemented method of claim 14, wherein the tree-based structure includes a first level of nodes each corresponding to one of the groups of data elements, and a second level of nodes each corresponding to one of the sub-groups of data elements.

16. The computer-implemented method of claim 9, wherein the first dimension includes size, and the second dimension includes color.

17. The computer-implemented method of claim 9, wherein the plurality of data elements are associated with a library of audio files.

18. The computer-implemented method of claim 17, wherein each of the first and second attributes includes one or more of the following: a volume of a group of audio files having a common characteristic, an average handle time of the group of audio files, a median handle time of the group of audio files, a standard deviation of the individual handle time of each one of the group of audio files, and a customer satisfaction feedback score associated with the audio files.

19. A system for generating a treemap display representing a plurality of data elements, the system comprising:
an interface for accepting a selection of display mode and for receiving a description of the plurality of data elements characterized by a first attribute and a second attribute; and
a processor for partitioning a treemap field into a plurality of cells according to the selection of the mode of display, each cell representing a group of data elements, the processor being further configured for:
computing a size of each of the plurality of cells based on the first attribute; and
computing a color of each of the plurality of cells based on the second attribute.

20. The system of claim 19, wherein the mode of display includes one or more of the following: a “global” mode, a “selected sessions” mode, a “sessions only” mode, a “per session” mode, and an “animated” mode.

21. The system of claim 19, wherein the processor is further configured for:
grouping at least some of the plurality of data elements into a first set of data elements according to a first rule associated with the first attribute;
partitioning the treemap field into a plurality of cells according to the grouping result, the plurality of cells including a first cell representing the first set of data elements, the first cell having a size corresponding to a value of the first attribute of the first set of data elements;
dividing the first set of data elements into a plurality of subsets of data elements according to a second rule; and
partitioning the first cell of the treemap field into a plurality of sub-cells according to the division, each sub-cell representing a respective one of the plurality of subsets of data elements.

22. The system of claim 19, wherein the processor is further configured for:
re-partitioning the treemap field in response to a modification in the selection of display mode.
